(19) United States
(12) Patent Application Publication
(10) Pub. No.: US 2019/0303158 A1
(43) Pub. Date: Oct. 3, 2019

(54) TRAINING AND UTILIZATION OF A NEURAL BRANCH PREDICTOR

(71) Applicant: QUALCOMM Incorporated, San Diego, CA (US)

(72) Inventors: Gurkanwal BRAR, Mountain View, CA (US); Christopher AHN, San Diego, CA (US); Gurvinder Singh CHHABRA, San Diego, CA (US)

(21) Appl. No.: 15/940,896

(22) Filed: Mar. 29, 2018

(51) Int. Cl. G06F 9/38; G06F 8/41; G06F 8/658; G06N 3/08

(52) U.S. Cl. CPC G06F 9/3806; G06F 9/3844; G06N 3/08; G06F 8/658; G06F 8/423

(57) ABSTRACT

Systems and methods for branch prediction include identifying a subset of branch instructions executable by a processor as a neural subset of branch instructions, based on information obtained from using an execution trace, wherein the neural subset of branch instructions are determined to have larger benefit from a neural branch predictor than a non-neural branch predictor. The neural branch predictor is pre-trained for the neural subset based on the execution trace. Annotations are added to the neural subset of branch instructions, wherein the annotations are preserved across software revisions. At runtime, when the neural subset of branch instructions are encountered during any future software revision, the branch instructions thereof are detected as belonging to the neural subset of branch instructions based on the annotations, and the pre-trained neural branch predictor is used for making their branch predictions.

### FIELD OF DISCLOSURE

Disclosed aspects are directed to branch prediction in processing systems. More specifically, exemplary aspects are directed to efficient utilization of neural branch predictors for branch prediction.

### BACKGROUND

Processing systems may employ instructions which cause a change in control flow, such as conditional branch instructions. The direction of a conditional branch instruction is based on how a condition evaluates, but the evaluation may only be known deep down an instruction pipeline of a processor. To avoid stalling the pipeline until the evaluation is known, the processor may employ branch prediction mechanisms to predict the direction of the conditional branch instruction early in the pipeline. Based on the prediction, the processor can speculatively fetch and execute instructions from a predicted address in one of two paths—a “taken” path which starts at the branch target address, with a corresponding direction referred to as the “taken direction”; or a “not-taken” path which starts at the next sequential address after the conditional branch instruction, with a corresponding direction referred to as the “not-taken direction”.

When the condition is evaluated and the actual branch direction is determined, if the branch was mispredicted, (i.e., execution followed a wrong path) the speculatively fetched instructions may be flushed from the pipeline, and new instructions in a correct path may be fetched from the correct next address. Accordingly, improving accuracy of branch prediction for conditional branch instructions mitigates penalties associated with mispredictions and execution of wrong path instructions, and correspondingly improves performance and energy utilization of a processing system.

Conventional branch prediction mechanisms may include one or more state machines which may be trained with a history of evaluation of past and current branch instructions. For example, a bimodal branch predictor uses two bits per branch instruction (which may be indexed using a program counter (PC) of the branch instruction, and also using functions of the branch history as well as a global history involving other branch instruction histories) to represent four prediction states: strongly taken, weakly taken, weakly not-taken, and strongly not-taken, for the branch instruction. While such branch prediction mechanisms are relatively inexpensive and involve a smaller footprint (in terms of area, power consumption, latency, etc.), their prediction accuracies are also seen to be low.

More complex branch prediction mechanisms are emerging in the art for improving prediction accuracies. Among these, complex branch prediction mechanisms, so called neural branch predictors (e.g., Perceptron, Fast Path branch predictors, Piecewise Linear branch predictors, etc.) utilize bias weights and weight vectors derived from individual branch histories and/or global branch histories in making branch predictions. However, these complex branch prediction mechanisms may also incur added costs in terms of area, power, and latency. The energy and resources expended in training the neural branch predictors for obtaining the bias weights, weight vectors, etc., as well as in utilizing the complex branch prediction mechanisms are seen to be particularly wasteful when mispredictions occur, albeit at a lower rate than the mispredictions which may result from the use of the simpler branch prediction mechanisms such as the bimodal branch predictor.

Furthermore, it is also observed that the benefits of neural branch predictors, e.g., measured in terms of branch prediction accuracy, are not uniform for all branch instructions. Rather, a subset of branch instructions (e.g., globally dependent branch instructions, branch instructions used in state-based workloads) are seen to gain the most significant benefits from branch prediction whereas the remaining branch instructions are observed to not have a significant improvement in their prediction accuracy. Furthermore, this subset of branch instructions which benefit from the neural branch predictors is also observed to cover a very small proportion of the overall set of branch instructions in a given application or workload.

However, conventional approaches which utilize neural branch predictors do not take into account the disproportionate benefit of the neural branch predictors across the set of branch instructions for which predictions are obtained. In other words, the neural branch predictors, when present, are used in obtaining branch predictions for all branch instructions without regard to potential benefits of utilizing such expensive mechanisms in each individual case. This leads to over-utilization of neural branch predictors and associated area, power, and latency costs in approaches wherein neural branch predictors are employed.

Furthermore, even if a subset of branch instructions are identified for which the benefits of neural branch predictors are likely to be high, known approaches do not have effective mechanisms for preserving these identifications across the different software versions, code changes, context switches, etc., of programs or applications executing on processors. The program counters (PCs) relating to the virtual address of the branch instructions may change with the software revisions, which also may complicate tracking the identified subset of branch instructions across software revisions. Problems related to virtual address aliasing may also arise, wherein multiple physical addresses may map to the same virtual address.

Additionally, the neural branch predictors may undergo a training phase wherein weights/coefficients for making individual branch predictions are established. Repeating the training phase for the same identified subset of branch instructions over the various code changes, software revisions, etc. may also lead to wastefulness of time and resources.

Thus, it is desirable to overcome the aforementioned problems while improving the utilization of neural branch predictors.

### SUMMARY

Exemplary aspects of the invention are directed to systems and methods for branch prediction. A subset of branch instructions of an instruction set executable by a processor are identified as a neural subset of branch instructions, based on information obtained from using an execution trace, wherein the neural subset of branch instructions are determined to have larger benefit from a neural branch predictor than a non-neural branch predictor. For this neural subset of branch instructions, the neural branch predictor is pre-trained based on the execution trace. For instance, the pre-training may comprise generating initial weights for the neural subset of branch instructions in a weight matrix used by the neural branch predictor in making branch predictions. Annotations, such as compiler directives are added to the neural subset of branch instructions, wherein the annotations are preserved across software revisions, code changes, etc. At run time, when the neural subset of branch instructions are encountered during any future software revision, the branch instructions thereof are detected as belonging to the neural subset of branch instructions based on the annotations and the pre-trained neural branch predictor is used for making their branch predictions.

For example, an exemplary aspect is directed to a method of branch prediction. The method comprises identifying a subset of branch instructions from an execution trace of instructions executed by a processor as a neural subset of branch instructions, wherein the neural subset of branch instructions are determined to have a greater benefit from branch predictions made by a neural branch predictor than branch predictions made by a non-neural branch predictor and pre-training the neural branch predictor for the neural subset of branch instructions. The method further comprises adding annotations to the neural subset of branch instructions, wherein the annotations are preserved for the neural subset of branch instructions across software revisions of code executing on the processor, and when one or more branch instructions of the neural subset of branch instructions are detected based on the annotations at runtime, using the pre-trained neural branch predictor for making branch predictions for one or more branch instructions of the neural subset of branch instructions

Another exemplary aspect is directed to an apparatus comprising a neural branch predictor configured to provide neural branch predictions of branch instructions executed by a processor, an identifier block configured to identify a subset of branch instructions from an execution trace of instructions executed by the processor as a neural subset of branch instructions, wherein the neural subset of branch instructions have greater benefit from branch predictions made by the neural branch predictor than branch predictions made by a non-neural branch predictor, a pre-training block configured to pre-train the neural branch predictor for the neural subset of branch instructions, and an annotation block configured to add annotations to the neural subset of branch instructions, wherein the annotations are preserved for the neural subset of branch instructions across software revisions of code executing on the processor. The neural branch predictor is configured to use the pre-trained neural branch predictor to make branch predictions for one or more branch instructions of the neural subset of branch instructions when one or more branch instructions of the neural subset of branch instructions are detected by a filter based on the annotations at runtime.

Another exemplary aspect is directed to an apparatus comprising means for identifying a subset of branch instructions from an execution trace of instructions executed by a processor as a neural subset of branch instructions, wherein the neural subset of branch instructions are determined to have a greater benefit from branch predictions made by a neural branch predictor than branch predictions made by a non-neural branch predictor, means for pre-training the neural branch predictor for the neural subset of branch instructions, means for adding annotations to the neural subset of branch instructions, wherein the annotations are preserved for the neural subset of branch instructions across software revisions of code executing on the processor, and means for using the pre-trained neural branch predictor for making branch predictions for one or more branch instructions of the neural subset of branch instructions when one or more branch instructions of the neural subset of branch instructions are detected based on the annotations at runtime

Yet another exemplary aspect is directed to a non-transitory computer readable storage medium comprising code, which when executed by a computer, causes the computer to perform operations for branch prediction, the non-transitory computer readable storage medium comprising: code for identifying a subset of branch instructions from an execution trace of instructions executed by a processor as a neural subset of branch instructions, wherein the neural subset of branch instructions are determined to have a greater benefit from branch predictions made by a neural branch predictor than branch predictions made by a non-neural branch predictor, code for pre-training the neural branch predictor for the neural subset of branch instructions, code for adding annotations to the neural subset of branch instructions, wherein the annotations are preserved for the neural subset of branch instructions across software revisions of code executing on the processor, and code for using the pre-trained neural branch predictor for making branch predictions for one or more branch instructions of the neural subset of branch instructions, when one or more branch instructions of the neural subset of branch instructions are detected based on the annotations at runtime.

### BRIEF DESCRIPTION OF THE DRAWINGS

The accompanying drawings are presented to aid in the description of aspects of the invention and are provided solely for illustration of the aspects and not limitation thereof.

FIG. 1A illustrates a processing system according to aspects of this disclosure.

FIG. 1B illustrates a process of identifying and annotating a subset of branch instructions predicted by a neural branch predictor, according to aspects of this disclosure.

FIG. 2 illustrates a flow-chart of a branch prediction method, according to aspects of this disclosure.

FIG. 3 depicts an exemplary computing device in which an aspect of this disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to systems and methods which overcome the above-mentioned problems associated with known branch prediction techniques. Specifically, a subset of branch instructions of an instruction set executable by a processor are identified, based on information obtained from using an execution trace, wherein the identified subset of branch instructions are determined to have larger benefit from a neural branch predictor than a non-neural branch predictor. For this identified subset of branch instructions, the neural branch predictor is pre-trained based on the execution trace. Annotations, such as compiler directives are added to the identified subset of branch instructions, wherein the annotations are preserved across software revisions, code changes, etc. At run time, when the identified subset of branch instructions are encountered during any future software revision, the branch instructions thereof are detected as belonging to the identified subset of branch instructions based on the annotations and the pre-trained neural branch predictor is used for making their branch predictions.

In this disclosure, terms such as software revisions, code changes, address remapping, etc., are used to convey events wherein addresses or program counter (PC) values of instructions executable on a processor may undergo changes. These changes may include, for example, changes to instruction organization, mapping of virtual-to-physical addresses, changes to programs or code blocks comprising instructions, changes to certain modes of operation, etc. Identifications of instructions (e.g., for being predicted by a neural branch predictor) which may be based on the addresses or PC values of the instructions may thus be lost or obfuscated in the event of such software revisions, code changes, or aliasing (wherein multiple virtual addresses may map to the same physical address). Thus, regardless of the specific type of software revision or code change that may affect the identification of the instructions, aspects of this disclosure include solutions (comprising combinations of software and hardware) to preserve the identifications of the subset of branch instructions which have been determined to have the highest benefit from neural branch predictors, referred to herein as the neural subset of branch instructions. Annotations such as compiler directives which are immune to software revisions, code changes, aliasing, etc., are added to the neural subset of branch instructions. In some instances of annotating the neural subset of branch instructions, attributes to identify the neural subset of branch instructions may be added by setting one or more bits in the instruction encoding to predetermined values.

In this disclosure, neural branch predictors generally refers to branch prediction mechanisms which utilize a weight vector comprising a set of weights which may be updated based on branching behavior and history of individual branch instructions as well as global history. Perceptron, Fast Path, Piecewise Linear predictor, etc., are known in the art as examples of such neural branch predictors. Branch predictors such as TAGE (which is an abbreviation of (partially) TAgged GEometric history length) which utilize contexts and histories in branch prediction may also be considered as examples of neural branch predictors. Similarly, various other complex branch prediction mechanisms which may have a larger benefit for a subset of branch predictions in accordance with this disclosure are also considered to be within the scope of the neural branch predictors discussed herein.

For remaining branch instructions outside the identified subset of branch instructions, simpler branch prediction mechanisms, also referred to as non-neural branch prediction mechanisms to distinguish them from the neural branch predictors, may be employed. Bimodal branch predictors, as known in the art, are described herein as one example of a non-neural branch prediction mechanism which may be used for branch prediction of the remaining branch instructions. Various other such branch predictors which may base predictions on a counter or state without involving the complex branch prediction mechanisms which are seen in neural branch predictors may also be considered as non-neural branch predictors to support hybrid approaches of using combinations of neural and non-neural branch predictors according to this disclosure.

In one aspect, branch instructions in the identified subset are determined to benefit more from neural branch predictors by comparing prediction accuracies of the branch instructions using a neural branch predictor as well as with a non-neural branch predictor, while also taking into account the frequency of occurrence of the branch instruction. For example, the benefit with respect to a branch instruction may be quantified as a difference between misprediction percentages or rates using the non-neural branch predictor and the neural branch predictor, with the difference multiplied by the frequency of occurrence of the branch instruction in the execution trace.

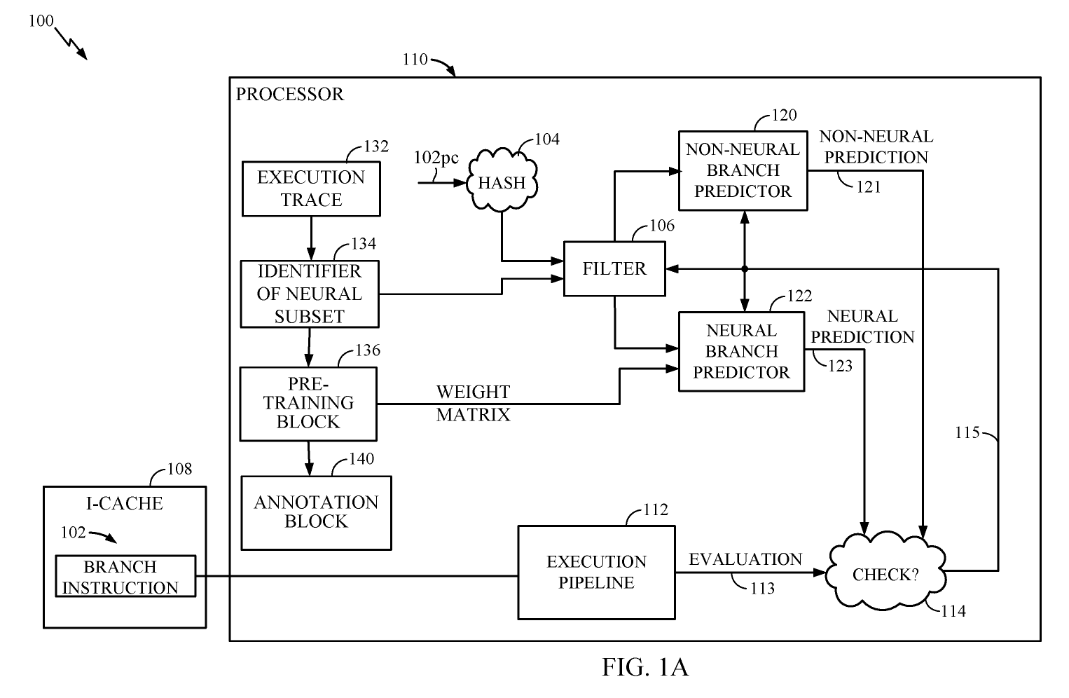

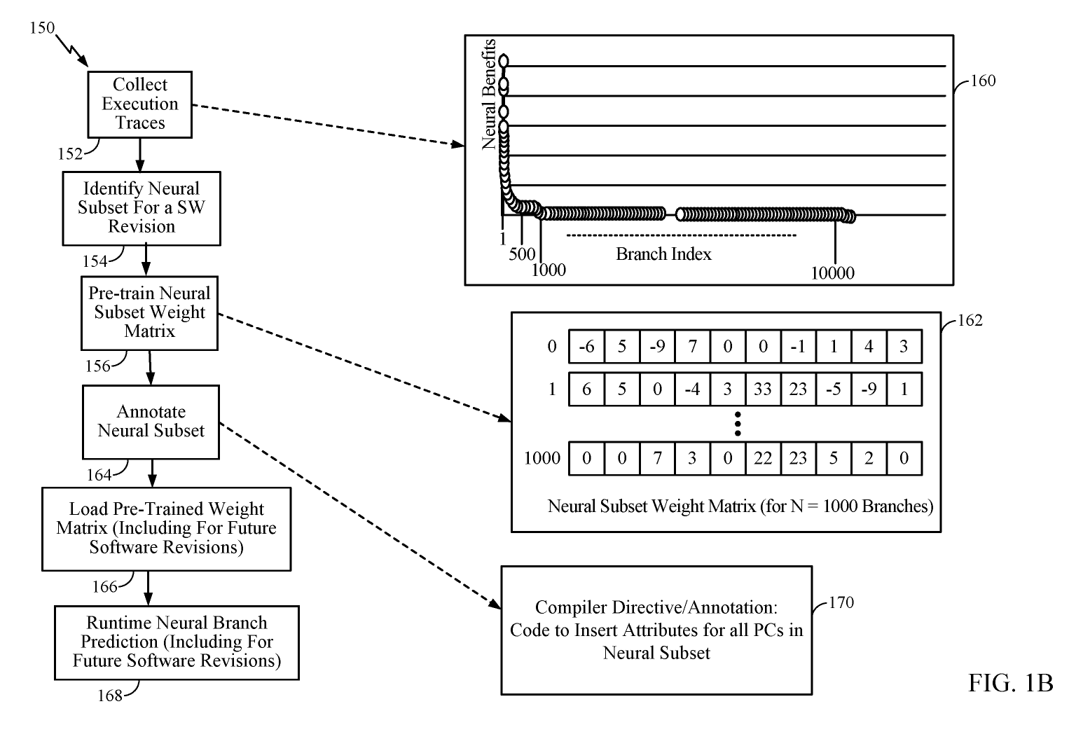

With reference now to FIG. 1A, an exemplary processing system 100 in which aspects of this disclosure may be employed, will first be described. Processing system 100 is shown to comprise processor 110 coupled to instruction cache 108. Although not shown in this view, additional components such as functional units, input/output units, interface structures, memory structures, etc., may also be present but have not been explicitly identified or described as they may not be germane to this disclosure. As shown, processor 110 may be configured to receive instructions from instruction cache 108 and execute the instructions using for example, execution pipeline 112. Execution pipeline 112 may be configured to include one or more pipelined stages such as instruction fetch, decode, execute, write back, etc., as known in the art. Representatively, a branch instruction is shown in instruction cache 108 and identified as branch instruction 102.

In an exemplary implementation, branch instruction 102 may have a corresponding address (e.g., virtual address) or program counter (PC) value of 102pc. When branch instruction 102 is fetched by processor 110 for execution, logic such as hash 104 (e.g., implementing an XOR function) may utilize the PC value 102pc (and/or other information such as a history of branch instruction 102 or global history) to access filter 106. In some implementations, hash 104 may not be present, and filter 106 may be directly accessed using the PC value 102pc.

Filter 106 is generally configured to filter out branch instructions, e.g., based on their PC values and/or based on the annotations described herein, for which a neural branch predictor will be beneficial for predicting their branch directions. In this regard, processor 110 may include functional blocks shown as execution trace 132 and identifier of neural subset 134 to aid in the filtering. In one aspect, execution trace 132 collects a trace of instructions executed by processor 110. Although shown as being configured within processor 110, execution trace 132 may be configured as a functional block outside processor 110 to collect the execution trace and provide the collected execution trace as an input to processor 110 without deviating from the scope of this discussion.

Identifier of neural subset 134 is configured to analyze the execution trace in block 132 to identify a subset of branch instructions whose direction will be predicted by a complex branch prediction mechanism, using exemplary processes discussed in FIG. 1B. An example of such a complex branch prediction mechanism is shown as neural branch predictor 122 (although it will be understood that the precise implementation of the complex branch prediction mechanism is not germane to this discussion, and as such, in various examples, neural branch predictor 122 may be implemented as a Perceptron, Fast Path, Piecewise Linear predictor, etc., or Tage predictors as known in the art).

The subset of branch instructions for which neural branch predictor 122 is used in this manner are referred to as the neural subset of branch instructions. Filter 106 is configured to receive the identification of the neural subset and direct the neural subset to neural branch predictor 122. From neural branch predictor 122, neural prediction 123 is obtained for the neural subset of branch instructions.

For the remaining branch instructions which do not belong to the neural subset of branch instructions, filter 106 is configured to direct the remaining branch instructions to a simpler or non-neural branch predictor, which, for the sake of illustration is shown as non-neural branch predictor 120. Non-neural branch predictor 120 may be implemented as a bimodal branch predictor, as known in the art, with a two-bit saturating counter which may be incremented upon a correct prediction and decremented upon a misprediction, with the two-bit saturating counter's value being representative of one of the four states: strongly not-taken, weakly not-taken, weakly taken, and strongly taken. Based on the current value of a two-bit saturating counter, e.g., pertaining to branch instruction 102, non-neural branch predictor 120 is configured to provide a bimodal prediction shown as non-neural prediction 121, which may be used for speculative execution of the remaining branch instructions. In exemplary aspects, for the remaining branch instructions for which non-neural branch predictor 120 may be utilized as noted above, neural branch predictor 122 may be gated off or powered down which can lead to energy savings.

Continuing with the description of FIG. 1A, the neural subset is passed to pre-training block 136, which is configured to pre-train a weight matrix which will be used by neural branch predictor 122. Furthermore, the neural subset is also annotated in annotation block 140, wherein the annotations are preserved for the neural subset of branch instructions across software revisions of code executing on processor 110. Example processes which may be implemented in blocks 136 and 140 will be further discussed with reference to FIG. 1B.

FIG. 1A also illustrates execution pipeline 112, wherein branch instruction 102 may be speculatively executed in execution pipeline 112 (based on a direction corresponding to either non-neural prediction 121 or neural prediction 123). After traversing one or more pipeline states, an actual evaluation of branch instruction 102 will be known, and this is shown as evaluation 113. Evaluation 113 is compared with the corresponding prediction for the branch instruction 102 (either non-neural prediction 121 or neural prediction 123) in prediction check block 114 to determine whether evaluation 113 matched the corresponding prediction (i.e., to determine whether branch instruction 102 was correctly predicted) or mismatched the corresponding neural prediction 123 (i.e., branch instruction 102 was mispredicted). In an example implementation, bus 115 comprises information comprising the correct evaluation 113 (taken/not-taken) as well as whether branch instruction 102 was correctly predicted or mispredicted. The information on bus 115 may be supplied to respective non-neural branch predictor 120 and to neural branch predictor 122. The information on bus 115 may be used to update the corresponding state machines, history, weight vectors, bias values, etc. The information on bus 115 may also be supplied to filter 106 for updating the filtering process, as will be explained in further detail in the following sections.

With reference now to FIG. 1B, process 150 according to exemplary aspects is shown. Process 150 includes a process flow for identifying the neural subset of branch instructions to be predicted by neural branch predictor 122 in filter 106, pre-training neural branch predictor 122 for the identified subset of branch instructions, and annotating the identified subset of branch instructions for future software revisions.

Starting with Block 152, execution traces of instructions executed by processor 110 are collected, e.g., by the block shown as execution trace 132 in FIG. 1A and discussed above. For the purposes of this discussion, all branch instructions in the execution trace may be predicted using a neural branch predictor such as neural branch predictor 122, as well as with non-neural branch predictor 120. The misprediction percentages or rates of both neural branch predictor 122, as well as non-neural branch predictor 120 in predicting the branch instructions may be calculated, e.g., by block 134 configured as the identifier of the neural subset, as shown in FIG. 1A and discussed above. Identifier of neural subset 134 may also obtain the frequency of occurrence in the execution trace for each branch instruction whose misprediction percentages are calculated. In one aspect, the benefit of using neural branch predictor 122 for a branch instruction may be quantified as: (misprediction rate using non-neural branch predictor 120−misprediction rate using neural branch predictor 122)*frequency of the branch instruction. This calculation may alternatively be viewed as a difference in misprediction rates of non-neural branch predictor 120 and neural branch predictor 122, the difference multiplied by the frequency of the branch instruction. Alternative techniques for comparing benefits of non-neural branch predictor 120 and neural branch predictor 122 for making branch predictions for the branch instructions in the execution trace may also be used without deviating from the scope of this disclosure. A comparison of the benefits leads to identification of the subset of branch instructions which benefit more from neural branch predictor 122, and for this subset, neural branch predictor 122 may be used at runtime, by providing an appropriate indication to filter 106 regarding the neural subset.

The above process pertaining to Block 152 may be performed offline or in a simulation mode and is distinguished from a runtime operation (or simply, “runtime”, also referred to as execution or active instruction processing). Furthermore, the processes in Block 152 may be based on the execution trace in block 132 of code pertaining to a given software revision, generally referred to as a first software revision. For instance, identifier of neural subset 134 may be configured to determine, for each branch instruction in execution trace 132: a frequency of the branch instruction in the execution trace and a difference between misprediction rates using neural branch predictor 122 and the non-neural branch predictor 120, and multiply the difference by the frequency. Identifier of neural subset 134 may be further configured to tabulate the benefits using neural branch predictor 122, e.g., in a graph shown as graph 160 with the benefits on the y-axis. On the x-axis, branch instructions from the instruction trace are ordered in descending order of the benefits, with index values starting with 1 being assigned to the branch instructions in the descending order.

As can be observed in the illustrated example of graph 160, the subset of branch instructions having indices from 1 to 1000 have non-zero benefits of using neural branch predictor 122 in their branch prediction, whereas the remaining branch instructions, starting approximately with index 1000 have no apparent benefits. Even within this subset of branch instructions having indices from 1 to 1000, a smaller number (e.g., with indices smaller than 500) are seen to have significantly larger benefits than the remaining branch instructions with indices of up to 1000. Thus, an even smaller number of branch instructions than the number of branch instructions with non-zero benefits may be chosen to belong to the neural subset of branch instructions for which neural branch predictor 122 may be used in making branch predictions. It will be understood that the above numerical values are merely for the sake of illustration and are not to be construed as implying any inherent limitation on the precise number or proportion of branch instructions in an instruction set which may benefit from neural branch prediction.

In Block 154, identifier of neural subset 134 may be configured to consult graph 160 and identify the neural subset of branch instructions (e.g., based on PC values 102pc, whose indices correspond to the indices between 0 and 1000 in the above example which have significant benefits from neural branch prediction). Block 154 may pertain to the first software revision for which execution trace 132 was analyzed in Block 152. The neural subset of branch instructions may be annotated by annotation block 140 according to exemplary aspects and provided to identifier of neural subset 134 at runtime for the first software revision or any second software revision which may be subsequent to the first software revision, such that filter 106 may direct the neural subset of branch instructions to neural branch predictor 122.

Block 156 represents an operation of pre-training neural branch predictor 122, e.g., as performed by pre-training block 136 of FIG. 1A described above. Although pre-training block 136 is separately shown to generate a weight matrix to be provided to neural branch predictor 122, in alternative implementations, the functionality of pre-training block 136 may be provided within neural branch predictor 122 to generate the initial weight matrix. Accordingly, in one aspect, during an offline process, the neural subset of branch instructions may be provided to pre-training block 136. Neural branch predictor 122 may have a weight vector for each one of the neural subset of branch instructions which are to be predicted using neural branch predictor 122. In example implementations, pre-training block 136 may pre-train the weight vectors based on a history of respective branch instructions as well as global history. In general, the more or better trained the weight vector is for a branch instruction, the better is the accuracy of prediction of the branch instruction's direction. Weight vectors 1-1000 are representatively shown for respective branch instructions with indices 0-1000 in weight vector matrix 162 which may be implemented in neural branch predictor 122. The branch instructions corresponding to indices 0-1000 may be annotated as will be described in Block 164 below. Further, as seen, weight vector matrix 162 comprises weight vectors for only the neural subset of branch instructions and not the entire set of branch instructions. This allows a smaller area and power consumption of neural branch predictor 122 as well as a more efficient training process wherein history of branch instructions which may not benefit from neural branch predictor 122 are not considered or allowed to affect or corrupt the training process.

Although not shown, various other aspects such as bias weights, global branch history tables, etc., may also be present in neural branch predictor 122 to aid in the branch prediction of the identified subset of branch instructions. In an example implementation, an initial bias weight and corresponding initial weight vector for branch instruction 102 may be generated by pre-training block 136 during the pre-training, which may be obtained using the index associated with branch instruction 102. In one aspect, these initial weights (bias weight, weight vector, etc.) may be used as static weights in branch prediction of branch instruction 102, using neural branch predictor 122.

In some aspects, the initial weights may be used as starting points and the initial weights may be updated during runtime for the present/first software revision or for future software revisions such as the second software revision. A combination of the indexed weight vector, associated bias weight, and global history may be used to generate a partial sum as known in the art, e.g., using the example formula, partial sum=bias weight+vector product (indexed weight vector, global history). Neural prediction 123 is obtained in one example as corresponding to the sign of the partial sum, wherein, positive and negative signs may respectively correspond to taken and not-taken predictions, without loss of generality. As mentioned with reference to FIG. 1A, once evaluation 113 is obtained for branch instruction 102, the information on bus 115 is utilized to update the indexed weight vector for branch instruction 102 accordingly. The precise processes involved in generating, maintaining, and updating the bias weights, weight vectors in weight vector matrix 162, etc., are beyond the scope of this disclosure, but have been briefly mentioned herein for the sake of illustration of one exemplary aspect.

The weight vectors in weight vector matrix 162 are initially generated by pre-training block 136 (e.g., offline or prior to runtime) for the identified subset of branch instructions by identifier of neural subset 134 based on execution traces 132. In some aspects, the initially generated weight vectors may be used as static weight values during runtime for the present or future software revisions, while in other aspects, they may be used as initial values which may get updated during runtime. Pre-training the weight vectors, specifically for the identified subset of branch instructions for which neural branch predictor 122 will be used for branch prediction enables weight vector matrix 162 to be pre-trained or warmed up at runtime. As can be appreciated, pre-training speeds up the process of warming up neural branch predictor 122 at runtime, which leads to further improvements in speed, efficiency, and accuracy of branch prediction of the identified subset of branch instructions using neural branch predictor 122.

In Block 164, the neural subset of branch instructions in Block 154 which are determined to have the greatest benefit from neural branch predictor 122 are annotated, e.g., in annotation block 140 shown in FIG. 1A and described previously. An example annotation which may be implemented in annotation block 140 in the form of adding compiler directives is shown in Block 170, wherein for all the PC values of the neural subset, an attribute may be inserted to indicate that they are neural branch instructions. These attributes may be in the form of setting one or more bits in the encoding of instructions of the neural subset to predetermined values.

By way of further explanation of the above annotation, it is recognized that the software for the program or application being run on processor 110 (comprising instructions such as branch instruction 102 stored in instruction cache 108) may undergo numerous revisions, rebuilds, etc. The program counter 102pc values (which may be associated with virtual addresses) of the instructions may change from one software revision to the next. Accordingly, the program counter 102pc values of the neural subset may not remain the same in the event of code changes, software revision updates, etc. There is also the possibility of there being aliasing issues with identifying the neural subset based on their virtual addresses because multiple physical addresses may map to the same virtual address during runtime. Therefore, the above-described annotations performed by annotation block 140 of FIG. 1A, e.g., according to Block 170 of FIG. 1B, are designed to be retained across different software revisions, code changes, etc., and are also immune to or protected against aliasing problems. The compiler directives added to the neural subset in Block 170 in the instruction encoding or the source code may be retained when instructions of the neural subset are compiled and executed during runtime during any software revision. For example, annotation block 140 may be configured to encode information into the neural subset that they are to use neural branch predictor 122 for their branch prediction in a compiler used to compile the source code to be executed on processor 110 (of FIG. 1A). In one implementation, annotation block 140 may use one or more free bits in branch instructions belonging to the neural subset to insert or encode a predetermined value which would be preserved across software revisions. These one or more bits will be referred to herein as “neural bits” for ease of description. When the neural subset is encountered by filter 106 at runtime, filter 106 may determine that they are to be predicted by neural branch predictor if their neural bits match the predetermined value.

In Block 166, the pre-trained weight matrix from Block 156 for the neural subset may be loaded into neural branch predictor 122 in advance of the neural subset being encountered at runtime. Subsequently, at runtime, in Block 168, for the present software revision or future software revisions, the neural subset, identified based on their annotations/compiler directives, may be predicted efficiently in neural branch predictor 122 which has already been warmed up with the pre-trained weight matrix.

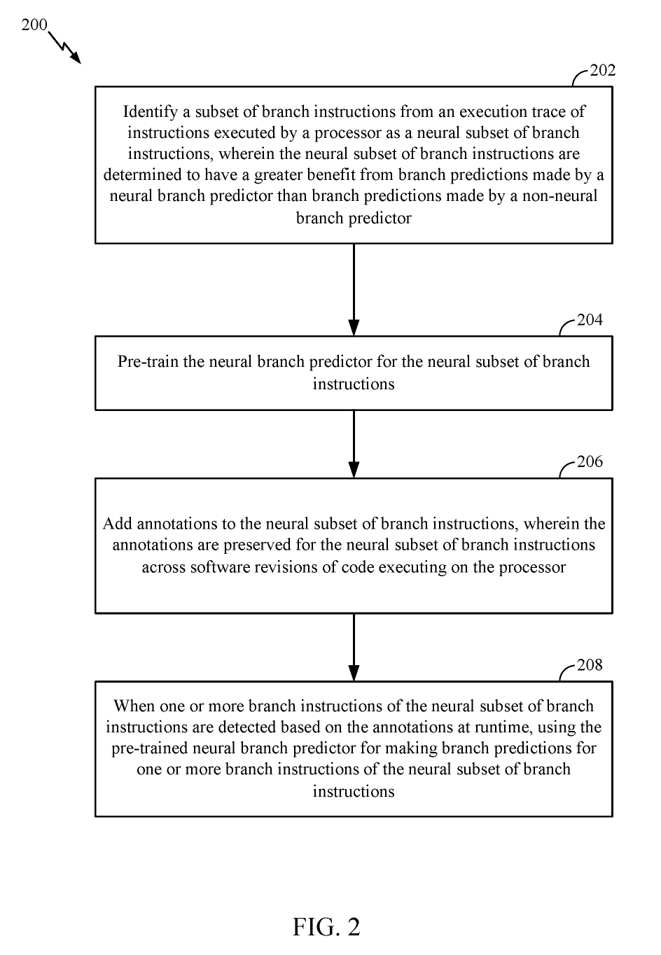

Accordingly, it will be appreciated that exemplary aspects include various methods for performing the processes, functions and/or algorithms disclosed herein. For example, FIG. 2 illustrates a method 200 of branch prediction.

Block 202 comprises identifying a subset of branch instructions from an execution trace of instructions executed by a processor as a neural subset of branch instructions, wherein the neural subset of branch instructions are determined to have a greater benefit from branch predictions made by a neural branch predictor than branch predictions made by a non-neural branch predictor (e.g., identifying branch instructions associated with indices 1 to 1000 from graph 160 in identifier of neural subset 134 based on execution trace 132 collected in block 152).

Block 204 comprises pre-training the neural branch predictor for the neural subset of branch instructions (e.g., determining initial weights for weight vectors of the branch instructions in pre-training block 136).

Block 206 comprises adding annotations to the neural subset of branch instructions, wherein the annotations are preserved for the neural subset of branch instructions across software revisions of code executing on the processor (e.g., adding compiler directives and/or other annotations to the neural subset in annotation block 140).

In Block 208, when one or more branch instructions of the neural subset of branch instructions are detected based on the annotations at runtime, using the pre-trained neural branch predictor for making branch predictions for one or more branch instructions of the neural subset of branch instructions (e.g., loading the pre-trained weight matrix from pre-training block 136 for the present or future software revisions and using neural branch predictor 122 for branch prediction of the neural subset).

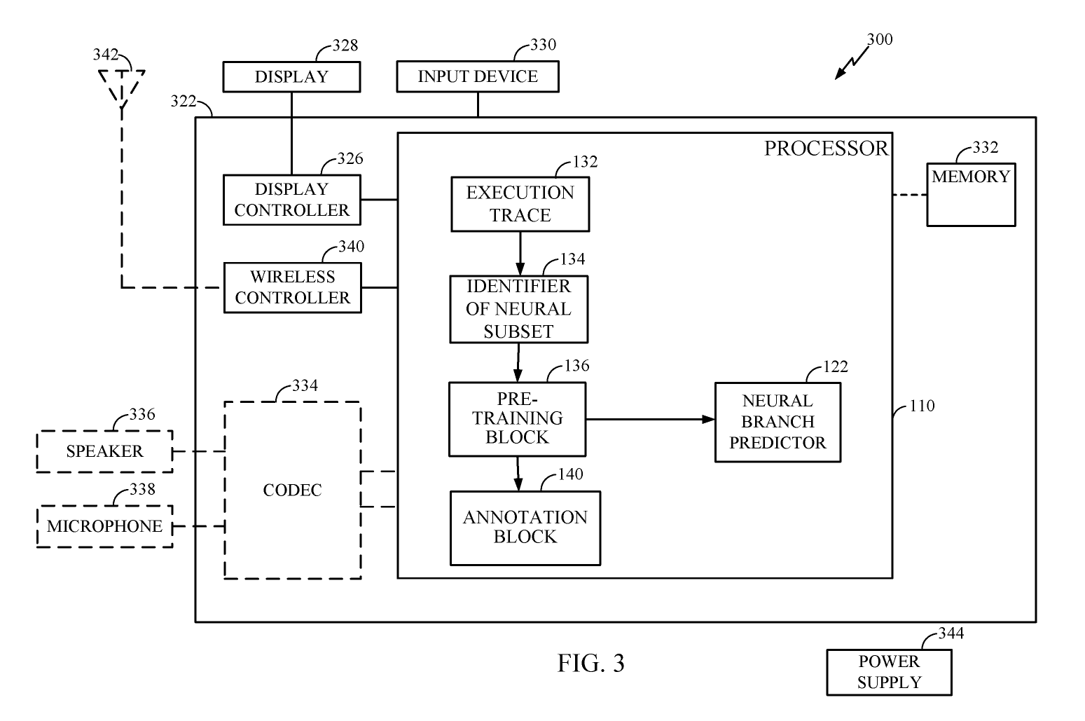

Another example apparatus, in which exemplary aspects of this disclosure may be utilized, will now be discussed in relation to FIG. 3. FIG. 3 shows a block diagram of computing device 300. Computing device 300 may correspond to an exemplary implementation of a processing system 100 of FIG. 1A, wherein processor 110 may be configured to perform method 200 of FIG. 2. In the depiction of FIG. 3, computing device 300 is shown to include processor 110, with only limited details (e.g., execution trace 132, identifier of neural subset 134, pre-training block 136, annotation block 140, and neural branch predictor 122) reproduced from FIG. 1A, for the sake of clarity. Notably, in FIG. 3, processor 110 is exemplarily shown to be coupled to memory 332, and it will be understood that other memory configurations known in the art such as instruction cache 108 have not been shown, although they may be present in computing device 300.

FIG. 3 also shows display controller 326 that is coupled to processor 110 and to display 328. In some cases, computing device 300 may be used for wireless communication, and FIG. 3 also shows optional blocks in dashed lines, such as coder/decoder (CODEC) 334 (e.g., an audio and/or voice CODEC) coupled to processor 110, and speaker 336 and microphone 338 can be coupled to CODEC 334; and wireless antenna 342 coupled to wireless controller 340 which is coupled to processor 110. Where one or more of these optional blocks are present, in a particular aspect, processor 110, display controller 326, memory 332, and wireless controller 340 are included in a system-in-package or system-on-chip device 322.

Accordingly, a particular aspect, input device 330 and power supply 344 are coupled to the system-on-chip device 322. Moreover, in a particular aspect, as illustrated in FIG. 3, where one or more optional blocks are present, display 328, input device 330, speaker 336, microphone 338, wireless antenna 342, and power supply 344 are external to the system-on-chip device 322. However, each of display 328, input device 330, speaker 336, microphone 338, wireless antenna 342, and power supply 344 can be coupled to a component of the system-on-chip device 322, such as an interface or a controller.

It should be noted that although FIG. 3 generally depicts a computing device 300, processor 110 and memory 332, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for branch prediction. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of branch prediction, the method comprising:
identifying a subset of branch instructions from an execution trace of instructions executed by a processor as a neural subset of branch instructions, wherein the neural subset of branch instructions are determined to have a greater benefit from branch predictions made by a neural branch predictor than branch predictions made by a non-neural branch predictor;
pre-training the neural branch predictor for the neural subset of branch instructions;
adding annotations to the neural subset of branch instructions, wherein the annotations are preserved for the neural subset of branch instructions across software revisions of code executing on the processor; and
when one or more branch instructions of the neural subset of branch instructions are detected based on the annotations at runtime, using the pre-trained neural branch predictor for making branch predictions for one or more branch instructions of the neural subset of branch instructions.

2. The method of claim 1, wherein adding the annotations comprises adding compiler directives to source code of the instructions executed by the processor.

3. The method of claim 2, wherein the compiler directives comprise setting one or more bits of branch instructions belonging to the neural subset of branch instructions to predetermined values.

4. The method of claim 1, comprising adding the annotations to the neural subset of branch instructions for a first software revision of the instructions and detecting the neural subset of branch instructions based on the annotations for a second software revision which is subsequent to the first software revision.

5. The method of claim 1, wherein the annotations are protected against aliasing when multiple physical addresses map to the same virtual address of the instructions executed by the processor.

6. The method of claim 1, wherein determining that the neural subset of branch instructions have greater benefit from branch predictions made by the neural branch predictor than branch predictions made by the non-neural branch predictor comprises:
determining, for each branch instruction in the execution trace of instructions according to a first software revision: a frequency of the branch instruction in the execution trace and a difference between misprediction rates using the neural branch predictor and the non-neural branch predictor; and
multiplying the difference by the frequency.

7. The method of claim 6, wherein pre-training the neural branch predictor comprises pre-training a weight vector matrix of the neural branch predictor to generate a pre-trained weight vector matrix based on the execution trace, the pre-trained weight vector matrix comprising weight vectors for the neural subset of branch instructions.

8. The method of claim 7, further comprising using the pre-trained weight vector matrix as a static weight vector during runtime, in obtaining branch predictions of the neural subset of branch instructions using the neural branch predictor.

9. An apparatus comprising:
a neural branch predictor configured to provide neural branch predictions of branch instructions executed by a processor;
an identifier block configured to identify a subset of branch instructions from an execution trace of instructions executed by the processor as a neural subset of branch instructions, wherein the neural subset of branch instructions have greater benefit from branch predictions made by the neural branch predictor than branch predictions made by a non-neural branch predictor;
a pre-training block configured to pre-train the neural branch predictor for the neural subset of branch instructions; and
an annotation block configured to add annotations to the neural subset of branch instructions, wherein the annotations are preserved for the neural subset of branch instructions across software revisions of code executing on the processor;
wherein the neural branch predictor is configured to use the pre-trained neural branch predictor to make branch predictions for one or more branch instructions of the neural subset of branch instructions when one or more branch instructions of the neural subset of branch instructions are detected by a filter based on the annotations at runtime.

10. The apparatus of claim 9, wherein the annotation block is configured to add compiler directives to source code of the instructions executed by the processor.

11. The apparatus of claim 10, wherein the compiler directives comprise one or more bits, of branch instructions belonging to the neural subset of branch instructions, set to predetermined values.

12. The apparatus of claim 9, wherein the annotation block is configured to add the annotations to the neural subset of branch instructions for a first software revision of the instructions and the identifier block is configured to detect the neural subset of branch instructions based on the annotations for a second software revision which is subsequent to the first software revision.

13. The apparatus of claim 9, wherein the annotations are protected against aliasing when multiple physical addresses map to the same virtual address of the instructions executed by the processor.

14. The apparatus of claim 9, wherein the identifier block is configured to
determine, for each branch instruction in the execution trace of instructions according to a first software revision: a frequency of the branch instruction in the execution trace and a difference between misprediction rates using the neural branch predictor and the non-neural branch predictor; and
multiply the difference by the frequency.

15. The apparatus of claim 14, wherein the pre-training block is configured to comprises pre-train a weight vector matrix of the neural branch predictor to generate a pre-trained weight vector matrix based on the execution trace, the pre-trained weight vector matrix comprising weight vectors for the neural subset of branch instructions.

16. The apparatus of claim 15, wherein the neural branch predictor is configured to use the pre-trained weight vector matrix as a static weight vector during runtime, to obtain branch predictions of the neural subset of branch instructions.

17. The apparatus of claim 9, integrated into a device selected from the group consisting of a set top box, a server, a music player, a video player, an entertainment unit, a navigation device, a personal digital assistant (PDA), a fixed location data unit, a computer, a laptop, a tablet, a communications device, and a mobile phone.

18. An apparatus comprising:
means for identifying a subset of branch instructions from an execution trace of instructions executed by a processor as a neural subset of branch instructions, wherein the neural subset of branch instructions are determined to have a greater benefit from branch predictions made by a neural branch predictor than branch predictions made by a non-neural branch predictor;
means for pre-training the neural branch predictor for the neural subset of branch instructions;
means for adding annotations to the neural subset of branch instructions, wherein the annotations are preserved for the neural subset of branch instructions across software revisions of code executing on the processor; and
means for using the pre-trained neural branch predictor for making branch predictions for one or more branch instructions of the neural subset of branch instructions when one or more branch instructions of the neural subset of branch instructions are detected based on the annotations at runtime.

19. The apparatus of claim 18, further comprising means for adding compiler directives to source code of the instructions executed by the processor.

20. The apparatus of claim 18, comprising means for adding the annotations to the neural subset of branch instructions for a first software revision of the instructions and means for detecting the neural subset of branch instructions based on the annotations for a second software revision which is subsequent to the first software revision.

21. The apparatus of claim 18, further comprising:
means for determining, for each branch instruction in the execution trace of instructions according to a first software revision: a frequency of the branch instruction in the execution trace and a difference between misprediction rates using the neural branch predictor and the non-neural branch predictor; and
means for multiplying the difference by the frequency.

22. The apparatus of claim 21, comprising means for pre-training a weight vector matrix of the neural branch predictor to generate a pre-trained weight vector matrix based on the execution trace, the pre-trained weight vector matrix comprising weight vectors for the neural subset of branch instructions.

23. The apparatus of claim 22, further comprising means for using the pre-trained weight vector matrix as a static weight vector during runtime, in obtaining branch predictions of the neural subset of branch instructions using the neural branch predictor.

24. A non-transitory computer readable storage medium comprising code, which when executed by a computer, causes the computer to perform operations for branch prediction, the non-transitory computer readable storage medium comprising:
code for identifying a subset of branch instructions from an execution trace of instructions executed by a processor as a neural subset of branch instructions, wherein the neural subset of branch instructions are determined to have a greater benefit from branch predictions made by a neural branch predictor than branch predictions made by a non-neural branch predictor;
code for pre-training the neural branch predictor for the neural subset of branch instructions;
code for adding annotations to the neural subset of branch instructions, wherein the annotations are preserved for the neural subset of branch instructions across software revisions of code executing on the processor; and
code for using the pre-trained neural branch predictor for making branch predictions for one or more branch instructions of the neural subset of branch instructions, when one or more branch instructions of the neural subset of branch instructions are detected based on the annotations at runtime.

25. The non-transitory computer readable storage medium of claim 24, comprising code for adding compiler directives to source code of the instructions executed by the processor.

26. The non-transitory computer readable storage medium of claim 25, wherein the code for adding the compiler directives comprises code for setting one or more bits of branch instructions belonging to the neural subset of branch instructions to predetermined values.

27. The non-transitory computer readable storage medium of claim 24, comprising code for adding the annotations to the neural subset of branch instructions for a first software revision of the instructions and code for detecting the neural subset of branch instructions based on the annotations for a second software revision which is subsequent to the first software revision.

28. The non-transitory computer readable storage medium of claim 24, wherein the code for determining that the neural subset of branch instructions have greater benefit from branch predictions made by the neural branch predictor than branch predictions made by the non-neural branch predictor comprises:
code for determining, for each branch instruction in the execution trace of instructions according to a first software revision: a frequency of the branch instruction in the execution trace and a difference between misprediction rates using the neural branch predictor and the non-neural branch predictor; and
code for multiplying the difference by the frequency.

29. The non-transitory computer readable storage medium of claim 28, wherein the code for pre-training the neural branch predictor comprises code for pre-training a weight vector matrix of the neural branch predictor to generate a pre-trained weight vector matrix based on the execution trace, the pre-trained weight vector matrix comprising weight vectors for the neural subset of branch instructions.

30. The non-transitory computer readable storage medium of claim 29, further comprising code for using the pre-trained weight vector matrix as a static weight vector during runtime, in obtaining branch predictions of the neural subset of branch instructions using the neural branch predictor.
